(19) United States
(12) Patent Application Publication
(10) Pub. No.: US 2024/0428135 A1
(43) Pub. Date: Dec. 26, 2024

(54) MACHINE LEARNING DEVELOPMENT SUPPORT SYSTEM AND MACHINE LEARNING DEVELOPMENT SUPPORT METHOD

(71) Applicant: Hitachi, Ltd., Tokyo (JP)

(72) Inventors: Tsutomu KUSABA, Tokyo (JP); Soichi TAKASHIGE, Tokyo (JP); Daisuke KOMAKI, Tokyo (JP)

(73) Assignee: Hitachi, Ltd., Tokyo (JP)

(21) Appl. No.: 18/747,830

(22) Filed: Jun. 19, 2024

(30) Foreign Application Priority Data
Jun. 21, 2023 (JP) 2023-101373

(51) Int. Cl. G06N 20/00

(52) U.S. Cl. CPC G06N 20/00

(57) ABSTRACT

A machine learning development support system includes: a data storage unit that stores training data; a data attribute extraction unit that refers to definition information whereby a conversion condition for converting the training data into an attribute thereof is defined and extracts data acquisition conditions from the training data; and an experiment record information storage unit that stores experiment record information., The machine learning product including a machine learning program and a trained model is divided into versions and recorded, and an accuracy of an inference obtained by each version is recorded in association with the version, the trained model, and the training data; and a processing specification unit that refers to the experiment record information, and specifies, for each of the data acquisition conditions, a machine learning product in which the accuracy of the inference is improved between old and new versions of the machine learning product.

### BACKGROUND OF THE INVENTION

### 1. Field of the Invention

The present invention relates to a machine learning development support system and a machine learning development support method.

### 2. Description of Related Art

In recent years, movement of applying machine learning to various business regions such as deep learning has been activated, and technique verification using machine learning has been performed. In the technique verification, a program, in which an algorithm of machine learning is implemented to operate on a system, and a trained model, which is trained by using the program and a training data set, are used. The program and the trained model are generally developed by a data scientist. The data scientist develops a program of machine learning and a trained model for the training data set collected by the data scientist, and improves the accuracy of the trained model.

There is a need to apply the program of machine learning and the trained model to cases of various types of technique verification by reusing the program of machine learning and the trained model which are developed by the data scientist. When the program of machine learning and the trained model are applied to a case of technique verification, system development of developing a system by incorporating the program of machine learning and the trained model into an application destination system, or application development of developing an application such that the program of machine learning and the trained model operate in an application destination task is required.

The system development or the application development as described above is often performed by a machine learning engineer instead of a data scientist. The machine learning engineer performs technique verification using the program of machine learning and the trained model which are developed by the data scientist and using data generated in the application destination system.

At this time, the machine learning engineer needs to focus on a difference between a condition in a development environment of the data scientist and a condition of the application destination system, for the program of machine learning and the trained model. Specifically, it is assumed that there are differences among the training data sets used for developing the trained model in the development environment of the data scientist, data acquisition conditions collected by the application destination system and task, and the like. In particular, the difference in the data acquisition conditions may affect an inference accuracy of an inference result obtained from the trained model.

When the program of machine learning and the trained model which are developed by the data scientist are applied to the application destination system, the machine learning engineer needs to confirm a difference in the data acquisition conditions and the like, and when an element that affects the inference accuracy is found, the machine learning engineer needs to modify the program of machine learning and the trained model. Therefore, the machine learning engineer needs to grasp a processing content implemented in the program of machine learning developed by the data scientist and information about the acquisition condition of the data from which the developed trained model is trained.

However, in a case where information required by the machine learning engineer is not stored as a development record at the time when the data scientist develops the program of machine learning and the trained model, the machine learning engineer is to read out the processing content implemented in the program of machine learning developed by the data scientist and grasp a processing condition, in which a desired inference accuracy can be expected, based on an experiment record and the like of the inference accuracy of the trained model. When such information is insufficient, the machine learning engineer may take a burden on task, which is a problem.

Therefore, a technique is desirable for the machine learning engineer to efficiently extract, as the development record, information required when applying the program of machine learning and the trained model to the application destination system, based on the program of machine learning and the trained model which are developed by the data scientist, the inference result that is accumulated in the process of development, the experiment record of the inference accuracy, and the like.

As a technique related to machine learning, for example, PTL 1 discloses a search system including an inference unit that executes an inference by each of a plurality of trained models using test data, a similarity calculation unit that calculates a similarity between inference results of the trained models as a similarity of the trained models, a grouping unit that divides the trained models into groups based on the similarity of the trained models, a summary unit that acquires features of the groups based on the inference results of the trained models belonging to the groups, and a selection unit that presents information according to the features of the groups.

PTL 2 discloses a model storage unit that stores a plurality of models trained in advance, an attribute processing unit that creates information on an attribute of recognition target data, and a model selection unit that selects, based on a degree of matching between the attribute of the recognition target data and an attribute of training data obtained by learning each model and diversity of the attribute of the recognition target data, a model used for recognition of the recognition target data from the plurality of models.

### CITATION LIST

### Patent Literature

PTL 1: JP2022-133861A

PTL 2: JP2021-81793A

### SUMMARY OF THE INVENTION

The technique disclosed in PTL 1 includes grouping the trained models according to the similarity of a plurality of inference results, generating a description of the group from a common portion of the inference results, and adding, to the trained models, a description obtained by summarizing the features held by the trained models.

However, in a case where the machine learning engineer wants to determine whether the program of machine learning and the trained model, which are developed by the data scientist, can be applied to the application destination system, only the description generated from the inference results of the trained model may be not sufficient as the development record. For example, the data acquisition condition of the application destination system in which the machine learning engineer is to perform the technique verification and the data acquisition condition used in the development environment of the data scientist may not necessarily match. Examples of the data acquisition condition include a season and the like in which time-series numerical data acquired from a sensor and the like attached to a facility of a factory is collected. In the technique disclosed in PTL 1, not only the difference in the data acquisition conditions but also modification of the machine learning program according to the difference is required.

The technique disclosed in PTL 2 creates the information on the attribute of the recognition target data of machine learning, and selects the trained model from the plurality of trained models by comparing the attribute with an attribute on training data set of a plurality of accumulated trained models.

When the data acquisition condition can be extracted as the attribute of the recognition target data, the machine learning engineer can grasp the difference in the data acquisition conditions by comparing the extracted data acquisition condition with the data acquisition condition of the application destination system and confirm whether there is an element that affects the inference accuracy.

However, even when the difference between the data acquisition condition used in the development environment by the data scientist and the data acquisition condition in the application destination system, in which the machine learning engineer is to perform the technique verification, and the element affecting the inference accuracy can be grasped, it is difficult for the machine learning engineer to improve the inference accuracy of the trained model with respect to the data acquisition condition in the application destination system. In order for the machine learning engineer to improve the accuracy of the trained model, not only the difference in the data acquisition conditions but also modification of the program of machine learning according to the difference is required.

If the machine learning engineer can modify the program of machine learning according to the difference in the data acquisition conditions, when the technique verification is performed on the program of machine learning and the trained model in the application destination system, the machine learning engineer can efficiently perform the technique verification by applying the data generated in the application destination system to the modified program of machine learning.

An object of the invention is to specify a machine learning product with an improved inference accuracy according to an attribute of training data, based on experiment record information indicating a history of the machine learning product including a machine learning program and a trained model.

In order to solve the above problem, the invention is a machine learning development support system including: a data storage unit configured to store training data used in training processing of a machine learning program; a data attribute extraction unit configured to refer to, based on the training data received from the data storage unit, definition information in which a conversion condition for converting the training data into an attribute thereof is defined, and extract a plurality of data acquisition conditions indicating the attribute from the training data; an experiment record information storage unit configured to store experiment record information, in which a machine learning product including the machine learning program and a trained model trained by the training processing of the machine learning program is divided into a plurality of versions and recorded, and an accuracy of an inference obtained by each of the versions of the machine learning product is recorded in association with the version of the machine learning product, the trained model, and the training data; and a processing specification unit configured to refer to the experiment record information for each of the data acquisition conditions extracted by the data attribute extraction unit, and specify, for each of the data acquisition conditions, a machine learning product in which the accuracy of the inference is improved between old and new versions among the versions of the machine learning product recorded in the experiment record information.

According to the invention, it is possible to specify a machine learning product with an improved inference accuracy according to an attribute of training data, based on experiment record information indicating a history of the machine learning product including a machine learning program and a trained model.

### BRIEF DESCRIPTION OF THE DRAWINGS

FIG. 1 is a configuration diagram showing a configuration example of a machine learning development support system according to an embodiment of the invention.

FIG. 2 is a configuration diagram showing an example of a hardware configuration of a development support server according to the embodiment of the invention.

FIG. 3 is a configuration diagram showing a configuration example of sensor data according to the embodiment of the invention.

FIG. 4 is a configuration diagram showing a configuration example of an annotation according to the embodiment of the invention.

FIG. 5 is a configuration diagram showing a configuration example of a machine learning program according to the embodiment of the invention.

FIG. 6 is a configuration diagram showing a configuration example of experiment record information according to the embodiment of the invention.

FIG. 7 is a configuration diagram showing a configuration example of a data acquisition condition according to the embodiment of the invention.

FIG. 8 is a configuration diagram showing a configuration example of accuracy variation information according to the embodiment of the invention.

FIG. 9 is a configuration diagram showing a configuration example of accuracy contribution information according to the embodiment of the invention.

FIG. 10 is a configuration diagram showing a configuration example of association information according to the embodiment of the invention.

FIG. 11 is a configuration diagram showing a configuration example of definition information according to the embodiment of the invention.

FIG. 12 is a flowchart showing an example of an operation of the development support server according to the embodiment of the invention.

FIG. 13A is a configuration diagram showing a display example of a search screen of a display unit according to the embodiment of the invention.

FIG. 13B is a configuration diagram showing a first display example of a search result display screen of the display unit according to the embodiment of the invention.

FIG. 13C is a configuration diagram showing a second display example of the search result display screen of the display unit according to the embodiment of the invention.

FIG. 13D is a configuration diagram showing a display example of the search result display screen of the display unit according to the embodiment of the invention.

### DESCRIPTION OF EMBODIMENTS

Hereinafter, embodiments of the invention will be described with reference to the drawings. In the following description, a program of machine learning is referred to as a machine learning program, and a set of a machine learning program and a trained model is referred to as a machine learning product.

### Embodiment

In a machine learning development support system according to the embodiment, a machine learning engineer supports a system constructed for proof of concept (PoC) or customers, and performs abnormality detection of a facility based on time-series data acquired from sensors and the like attached to the facility in the factory. Examples of the facility in the factory include a device such as a gas turbine. At this time, the time-series data acquired from a sensor (temperature sensor, pressure sensor) and the like attached to the gas turbine is input, training processing is performed by the machine learning program based on the time-series data, and a trained model is output. In the embodiment of the invention, the time-series data from the output of the sensor attached to the facility in the factory is described as an example, a target of the invention is not limited to the time-series data of the sensor attached to the facility in the factory.

### System Configuration Example

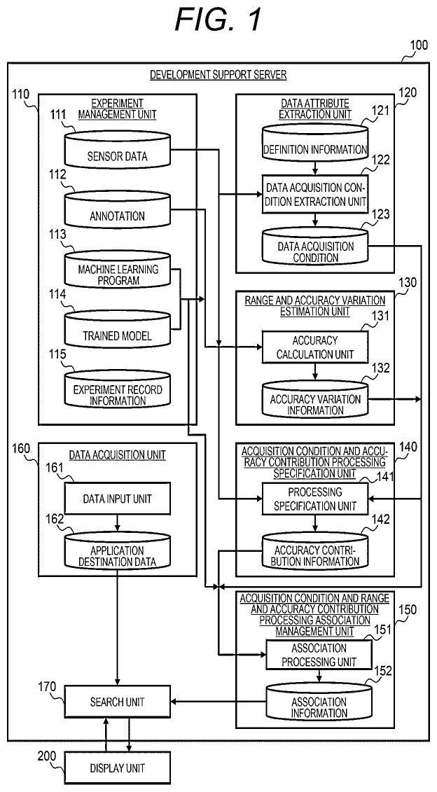

FIG. 1 is a configuration diagram showing a configuration example of the machine learning development support system according to the embodiment of the invention. In FIG. 1, the machine learning development support system includes a development support server 100 and a display unit 200 as an output unit. The development support server 100 is communicably connected to the display unit 200 used by a user of the machine learning development support system, for example, a machine learning engineer.

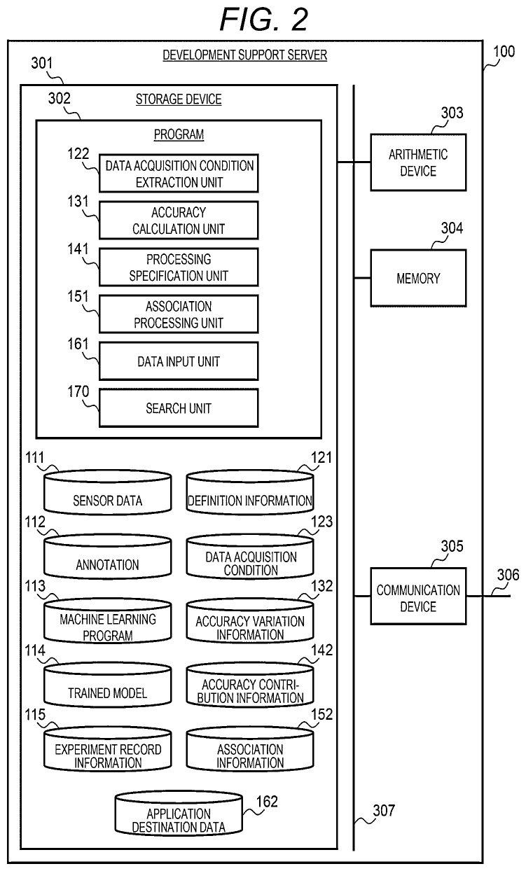

The development support server 100 includes, as software resources, for example, an experiment management unit 110, a data attribute extraction unit 120, a range and accuracy variation estimation unit 130, an acquisition condition and accuracy contribution processing specification unit 140, an acquisition condition and range and accuracy contribution processing association management unit 150, a data acquisition unit 160, and a search unit 170. A hardware configuration of the development support server 100 is shown in FIG. 2.

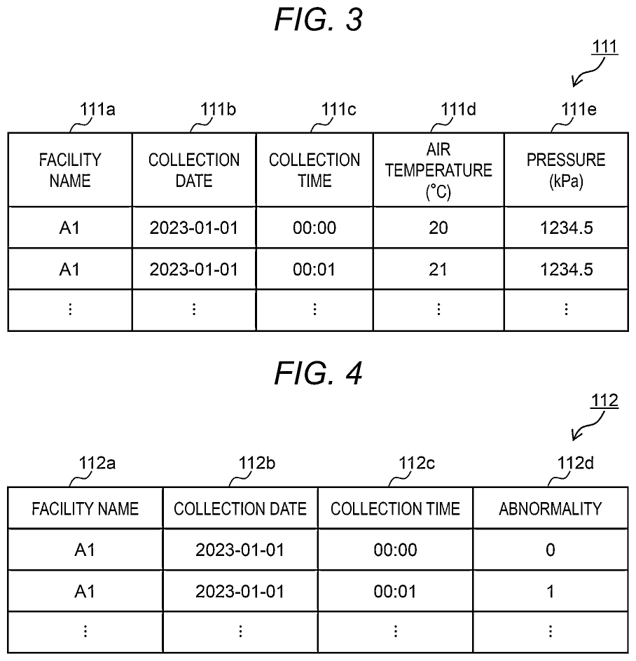

The experiment management unit 110 includes sensor data 111, an annotation 112, a machine learning program 113, a trained model 114, and experiment record information 115. The sensor data 111, the annotation 112, and data recorded in the experiment record information 115 are data used when a data scientist develops a machine learning product. The machine learning program 113 and the trained model 114 are a program and a model that are used when the data scientist develops the machine learning product. Examples of the sensor data 111, the annotation 112, the machine learning program 113, and the experiment record information 115 are shown in FIGS. 3, 4, 5, and 6, respectively. In addition to the data and the like used when the data scientist develops the machine learning product, data and the like developed by another server and the like can be input via the data acquisition unit 160 and the received data and the like can also be stored in the experiment management unit 110.

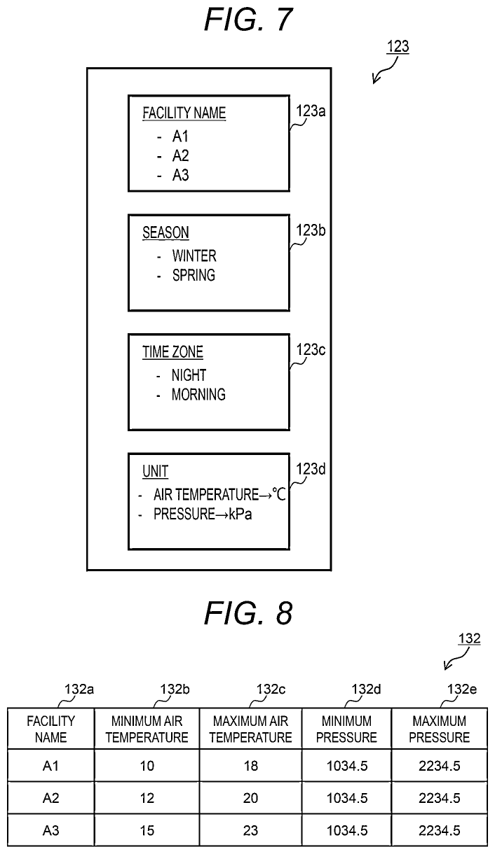

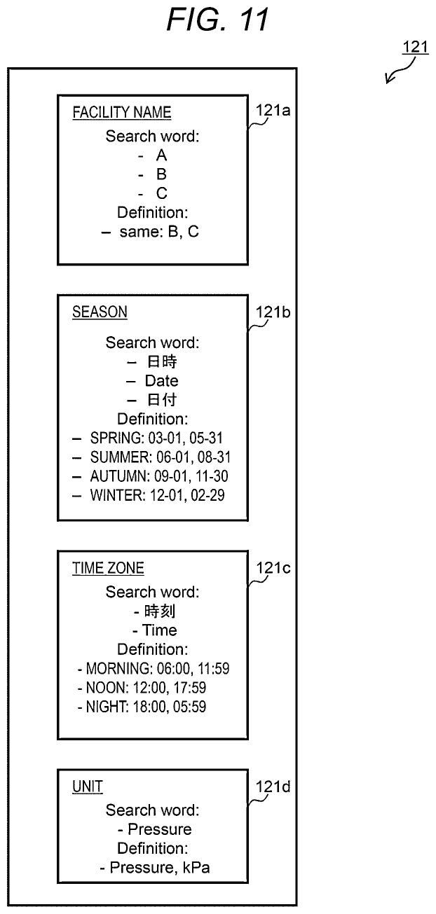

The data attribute extraction unit 120 includes definition information 121, a data acquisition condition extraction unit 122, and a data acquisition condition 123. Information on a conversion condition for converting the sensor data 111 into an attribute thereof (facility name, season, time zone, and unit) is recorded in the definition information 121 (see FIG. 11). Information related to the attributes (facility name, season, time zone, and unit) of the sensor data 111 is stored in the data acquisition condition 123 (see FIG. 7). The data acquisition condition extraction unit 122 acquires the sensor data 111 from the experiment management unit 110, refers to the definition information 121 based on the acquired sensor data 111, and extracts the data acquisition condition 123 indicating the attribute from the sensor data 111 based on a reference result.

At this time, the data acquisition condition extraction unit 122 specifies a column name of the sensor data 111 and a data type stored in each column among the acquired sensor data 111 (data including a facility name, a collection date, a collection time, an air temperature, and a pressure as names of fields), collates the specified column name with the definition information 121, determines a column name matching information described in the definition information 121 based on a collation result, and obtains the data acquisition condition 123 from a determination result. For example, when the “collection date” is specified as the column name in the acquired sensor data 111, the data acquisition condition extraction unit 122 extracts the sensor data 111 for all rows stored in the column (field) of the specified column name “collection date”, and collates the extracted sensor data 111 for all rows with the definition information 121. At this time, when the “collection date” for all rows corresponds to the “season” in the definition information 121, the data acquisition condition extraction unit 122 extracts the “season” as the attribute of the sensor data 111 from the data acquisition condition 123 including the facility name, the season, the time zone, and the unit. That is, the data attribute extraction unit 120 has a function of referring to the definition information 121 based on the sensor data 111 and extracting the data acquisition condition 123 indicating the attribute thereof from the sensor data 111.

The definition information 121 and the column name may be determined by partial matching and the like in consideration of an orthographical variant of the column name. Specific examples of the sensor data 111 and the data acquisition condition 123 will be described with reference to FIGS. 3 and 7. Here, in the embodiment, a format of the sensor data 111 is described as an example, but in a case where information related to the data acquisition condition 123 is stored in metadata of the data when a format other than the sensor data 111 is targeted, the data acquisition condition 123 may be extracted from the metadata.

The range and accuracy variation estimation unit 130 includes an accuracy calculation unit 131 and accuracy variation information 132. The accuracy calculation unit 131 acquires the sensor data 111, the annotation 112, the machine learning program 113, and the trained model 114 from the experiment management unit 110, and calculates the accuracy variation information 132 based on the acquired data, program, and the like. For example, in a case of “air temperature” in the columns of the sensor data 111, the accuracy calculation unit 131 acquires a maximum value and a minimum value from data belonging to the “air temperature” in the sensor data 111 on the condition that a state of the facility is normal (a column of “abnormality 112d” in the annotation 112 is “0”). Next, the accuracy calculation unit 131 adds a constant to the maximum value and the minimum value of the acquired “air temperature”, inputs the sensor data of the maximum value and the minimum value, to which the constant is added, and the trained model 114 to the machine learning program 113, and infers the presence or absence of abnormality in the facility by the processing of the machine learning program 113. At this time, the sensor data 111 to be received may be only data in a row in which the maximum value and the minimum value are stored, instead of the data in all the rows.

When the result of the inference performed by the processing of the machine learning program 113 is 0 (the facility is normal), the accuracy calculation unit 131 repeats processing of adding a constant again to the sensor data of the maximum value and the minimum value, to which the constant is added, and executing inference performed by the machine learning program 113 again until the inference result becomes 1 (the facility is abnormal). When the inference result becomes 1 (facility is abnormal), the accuracy calculation unit 131 sets the maximum value and the minimum value when the inference result becomes 1 as a maximum air temperature (upper limit value) and a minimum air temperature (lower limit value) of a range in the temperature, and stores information of the maximum air temperature and the minimum air temperature in the accuracy variation information 132. For example, in a case where the column in the sensor data 111 is the “air temperature”, when the result of the inference performed by the processing of the machine learning program 113 varies from normal to abnormal, the accuracy calculation unit 131 estimates, as the maximum air temperature (upper limit value) and the minimum air temperature (lower limit value) of the range in the temperature, the maximum value and the minimum value of the temperature used as the training data. That is, the accuracy calculation unit 131 functions as a range estimation unit that estimates a range of the sensor data (training data) 111 in which the inference result obtained by the training processing of the machine learning program 113 using the trained model 114 trained by the training processing of the machine learning program 113 and the sensor data (training data) 111 varies from normal to abnormal. An example of the accuracy variation information 132 is shown in FIG. 8, and will be described in a data structure example described later. The accuracy calculation unit 131 may calculate the accuracy variation information 132 by a known method such as the technique disclosed in PTL 1.

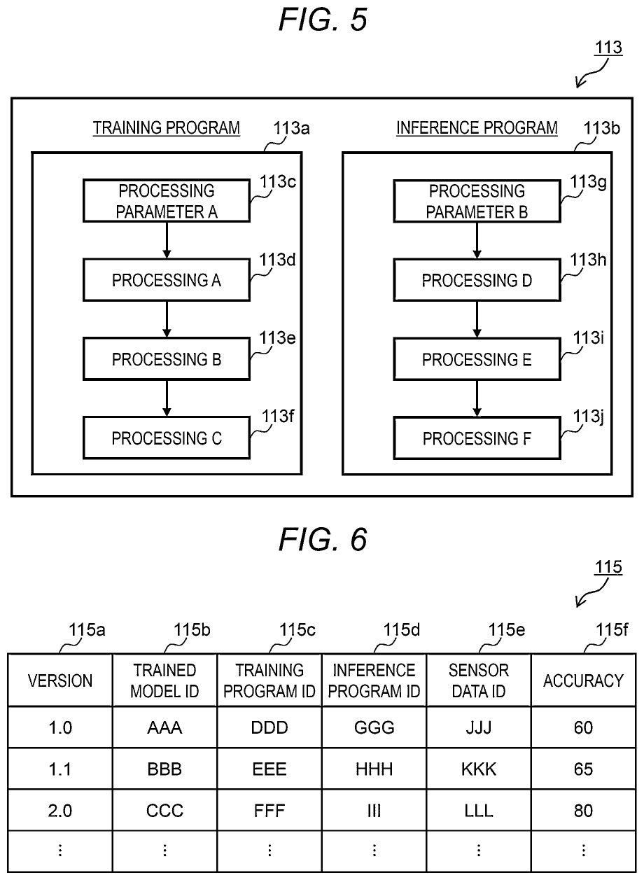

The acquisition condition and accuracy contribution processing specification unit 140 includes a processing specification unit 141 and accuracy contribution information 142. The processing specification unit 141 acquires the sensor data 111, the annotation 112, the machine learning program 113, the trained model 114, and the experiment record information 115 from the experiment management unit 110, acquires the data acquisition condition 123 from the data attribute extraction unit 120, and generates the accuracy contribution information 142 based on the acquired data, program, and the like. At this time, the acquisition condition and accuracy contribution processing specification unit 140 specifies, for each data acquisition condition extracted in the data acquisition condition 123, processing parameter or processing that has contributed to the improvement of the inference accuracy of the machine learning product from a training program 113a and an inference program 113b (see FIG. 5) constituting the machine learning program 113. At this time, the processing specification unit 141 refers to the experiment record information 115 for each data acquisition condition extracted by the data attribute extraction unit 120, specifies, for each data acquisition condition, a machine learning product, in which an accuracy of an inference is improved between old and new versions, among a plurality of machine learning products recorded in the experiment record information 115, and generates the accuracy contribution information 142 by collecting, for each data acquisition condition, a relationship between a change difference of the machine learning program 113 belonging to the specified machine learning product and the machine learning program 113. In addition, the processing specification unit 141 extracts two versions 115a having a certain level or more of accuracy improvement between the versions 115a of the experiment record information 115 shown in FIG. 6, and specifies a difference between the machine learning programs 113 of the extracted two versions 115a.

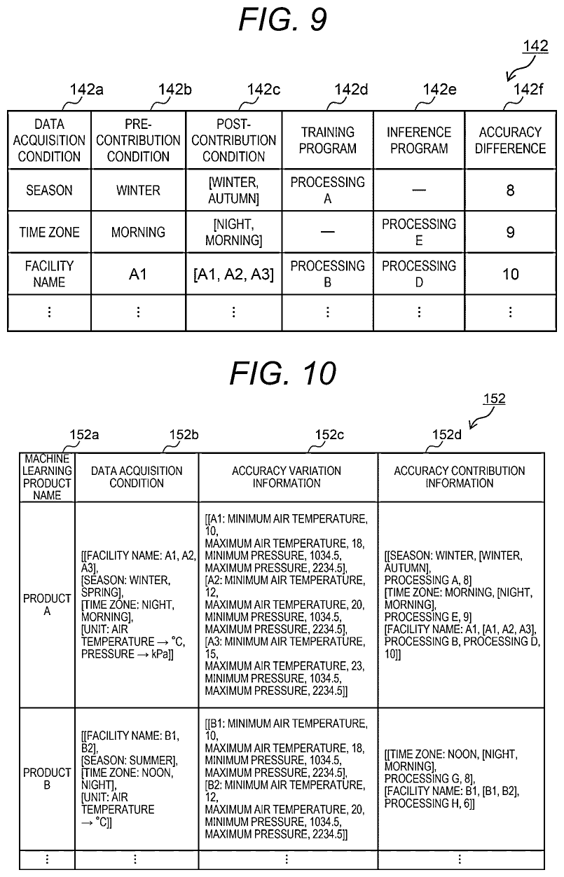

In the experiment record information 115 (see FIG. 6), a trained model ID 115b that can uniquely specify the trained model 114, a training program ID 115c that can uniquely specify the training program 113a, an inference program ID 115d that can uniquely specify the inference program, a sensor data ID 115e that can uniquely specify the sensor data 111, and an accuracy 115f of the machine learning product calculated based on the sensor data 111 and the annotation 112 are recorded for each version 115a of the machine learning product. An example of the accuracy contribution information 142 is shown in FIG. 9, and will be described in a data structure example described later.

The acquisition condition and range and accuracy contribution processing association management unit 150 includes an association processing unit 151 and association information 152. The association processing unit 151 acquires the machine learning program 113 and the trained model 114 from the experiment management unit 110, acquires the data acquisition condition 123 from the data attribute extraction unit 120, acquires the accuracy variation information 132 from the range and accuracy variation estimation unit 130, acquires the accuracy contribution information 142 from the acquisition condition and accuracy contribution processing specification unit 140, and generates the association information 152 based on the acquired data, program, and the like. The association processing unit 151 performs association processing on data so that a machine learning engineer described later can search the machine learning program 113, the trained model 114, and the accuracy contribution information 142 by the search unit 170 based on search conditions of the data acquisition condition 123 and the accuracy variation information 132. An example of the association information 152 is shown in FIG. 10, and will be described in a data structure example described later.

The data acquisition unit 160 includes a data input unit 161 and application destination data 162. The data input unit 161 inputs data collected by the application destination system in which the machine learning engineer performs technique verification, and stores, in a database, the received data as the application destination data 162. Similarly to the sensor data 111, the application destination data 162 includes time-series data (data including a facility name, a collection date, a collection time, an air temperature, and a pressure as names of fields). In addition, the sensor data 111, the annotation 112, the machine learning program 113, the trained model 114, and the experiment record information 115 may also be stored in the experiment management unit 110 using the data input unit 161.

The search unit 170 acquires the association information 152 from the acquisition condition and range and accuracy contribution processing association management unit 150, acquires the application destination data 162 from the data acquisition unit 160, acquires input data including a search condition from the display unit 200, searches the association information 152 based on the acquired input data, and transmits information indicating a search result to the display unit 200. At this time, the search unit 170 searches for information corresponding to the search condition from the association information 152 based on a degree of matching of the data acquisition condition 123 and a degree of matching of the accuracy variation information 132, and transmits, as corresponding information, for example, a machine learning product name 152a and accuracy contribution information 152d shown in FIG. 10 to the display unit 200. That is, the search unit 170 searches the association information (FIG. 10) using information recorded in the received input data as a search key. At this time, when the application destination data 162 acquired from a target of the technique verification is input as the input data, the search unit 170 extracts a data acquisition condition (application destination data acquisition condition) corresponding to the attribute of the sensor data 111 from the application destination data 162, extracts, as information associated with the extracted application destination data acquisition condition, at least one of the accuracy variation information 132 and the accuracy contribution information 142 from the association information 152, and outputs the extracted information to the display unit 200.

The display unit 200 is a display device that displays, on a screen, information obtained by the search performed by the search unit. At this time, the display unit 200 transmits, as a search condition, the input data received from the search screen to the search unit 170, and displays, that is, outputs information indicating a search result returned from the search unit 170.

With the above configuration, when the machine learning program 113 and the trained model 114 are applied to the application destination system, the machine learning engineer can efficiently use the accuracy variation information 132, the accuracy contribution information 142, and the association information 152 as information to be referred to.

### Hardware Configuration Example

FIG. 2 is a configuration diagram showing an example of the hardware configuration of the development support server according to the embodiment of the invention. In FIG. 2, the development support server 100 is a computer including a storage device 301, an arithmetic device 303, a memory 304, and a communication device 305, and each unit is connected to one another via a bus 307.

The storage device 301 is implemented by a nonvolatile storage element such as a solid state drive (SSD) and a hard disk drive. The storage device 301 stores the data acquisition condition extraction unit 122, the accuracy calculation unit 131, the processing specification unit 141, the association processing unit 151, the data input unit 161, and the search unit 170 as a program 302 that defines an operation of the arithmetic device 303. Further, the storage device 301 stores the sensor data 111, the annotation 112, the machine learning program 113, the trained model 114, the experiment record information 115, the definition information 121, the data acquisition conditions 123, the accuracy variation information 132, the accuracy contribution information 142, the association information 152, and the application destination data 162 as various types of data and information used or generated in the arithmetic device 303. The memory 304 is implemented by a volatile storage element including a random access memory (RAM).

The arithmetic device 303 is implemented by a processor such as a central processing unit (CPU). The arithmetic device 303 reads the program 302 stored in the storage device 301 to the memory 304, loads the program 302, and executes processing performed by the loaded program 302. Accordingly, the functions of the experiment management unit 110, the data attribute extraction unit 120, the range and accuracy variation estimation unit 130, the acquisition condition and accuracy contribution processing specification unit 140, the acquisition condition and range and accuracy contribution processing association management unit 150, the data acquisition unit 160, and the search unit 170 shown in FIG. 1 can be implemented. The communication device 305 can communicate with an external device such as the display unit 200 shown in FIG. 1 via a network 306.

### Data Structure Example

Next, a structure example of data used in the embodiment will be described. In the following description, data is represented by table data in a table format including a plurality of columns and rows, or text data in a text format. In this table format, each column in the table may be referred to as a field.

FIG. 3 is a configuration diagram showing a configuration example of the sensor data according to the embodiment of the invention. In FIG. 3, the sensor data 111 is training data used for the training processing of the machine learning program 113, and is stored in the database as time-series data obtained from the sensor attached to the facility of the factory. At this time, the sensor data 111 is managed as the table data (data in a table including a plurality of columns and rows) in a table format including a facility name 111a, a collection date 111b, a collection time 111c, an air temperature (° C.) 111d, and a pressure (kPa) 111e as a plurality of fields. A character string or numerical data is recorded in each row of each column in the table data. Specifically, the facility name 111a is an identification name for uniquely identifying the facility. For example, when a name of the facility (facility name) is A1, information of “A1” is stored in the facility name 111a. The facility name 111a may include not only the facility of the factory but also a facility other than the facility of the factory. In addition, the facility name 111a may be a character string type as the data type. The collection date 111b is a date when the time-series data is collected from the sensor. For example, when the time-series data is collected from the sensor on Jan. 1, 2023, information of “2023-01-1” is stored in the collection date 111b. The collection date 111b may be a DATE type as the data type.

The collection time 111c is a time at which the time-series data is collected from the sensor. For example, when the time at which the time-series data is collected from the sensor is 0:00 a.m., information of “00:00” is stored in the collection time 111c. The collection time 111c may be a TIME type. The air temperature (° C.) 111d is an outside air temperature indicating an external environment of the facility on the date and the collection time when the time-series data is collected, and is, for example, a measurement value of a temperature sensor disposed in the facility. For example, when the measurement value of the temperature sensor is 20° C., information of “20” is stored in the air temperature (° C.) 111d. The air temperature (° C.) 111d may be a Float type as the data type. The pressure (kPa) 111e is a pressure of the facility on the date and the collection time when the time-series data is collected, and is, for example, a measurement value of a pressure sensor disposed in the facility. For example, when the measurement value of the pressure sensor is 1234.5 kPa, information of “1234.5” is stored in the pressure (kPa) 111e. The pressure (kPa) 111e may be a Float type as the data type. Each field in FIG. 3 is an example of the sensor data 111 in the embodiment, and is not limited to this example. Any information can be stored in any field that can be generated as time-series data. The database that stores the sensor data 111 is implemented as a data storage unit that stores the training data used for the training processing of the machine learning program.

FIG. 4 is a configuration diagram showing a configuration example of the annotation according to the embodiment of the invention. In FIG. 4, the annotation 112 is data set by an operator as training data indicating the presence or absence of an abnormality in the facility, and is managed as table data in a table format. In this case, the annotation 112 includes a facility name 112a, a collection date 112b, a collection time 112c, and an abnormality 112d as a plurality of fields. The facility name 112a is a name of a facility that uniquely identifies the facility. For example, when the name of the facility (facility name) is A1, information of “A1” is stored in the facility name 112a. The facility name 112a may include not only the facility of the factory but also a facility other than the facility of the factory. In addition, the facility name 112a may be a character string type as the data type. The collection date 112b is a date when the information recorded in the annotation 112 is collected. For example, when the information collected on Jan. 1, 2023, is recorded in the annotation 112, information of “2023-01-01” is stored in the collection date 112b. The collection date 112b may be a DATE type as the data type.

The collection time 112c is a time at which the information recorded in the annotation 112 is collected. For example, when the time at which the information recorded in the annotation 112 is collected is 0:00 a.m., information of “00:00” is stored in the collection time 112c. The collection time 112c may be a TIME type. The abnormality 112d is information indicating whether the state of the facility is abnormal on the date and time when the information recorded in the annotation 112 is collected. In the abnormality 112d, information of “0” is stored when the state of the facility is normal, and information of “1” is stored when the state of the facility is abnormal. FIG. 5 is a configuration diagram showing a configuration example of the machine learning program according to the embodiment of the invention. In FIG. 5, the machine learning program 113 is a program when the training processing is executed using the sensor data 111 as the training data, and includes the training program 113a and the inference program 113b. The training program 113a includes, in the description of the training program 113a, a processing parameter A 113c and a plurality of types of processing A 113d, processing B 113e, and processing C 113f for executing the training processing of the trained model 114. The processing parameter A 113c is a processing parameter related to training used when the training program 113a executes the training processing. For example, the processing parameter A 113c includes the number of Epoch that defines the number of repetitions of the training processing, and the number of batches that are groups into which data sets necessary for performing the training processing are divided. The processing A 113d to the processing C 113f are functions or processing related to the training processing necessary for the training program 113a to generate the trained model 114. In this example, the processing A 113d to the processing C 113f are executed in this order, but the execution order may be free.

The inference program 113b includes, in the description of the inference program 113b, a processing parameter B 113g and processing D 113h, processing E 113i, and processing F 113f necessary for generating an inference result. The processing parameter B 113g is a processing parameter related to inference used when the inference program 113b executes inference processing. For example, there is a parameter and the like related to a threshold used in the inference processing performed by the inference program 113b. The processing D 113h to the processing F 113f are functions and processing for the inference program 113b to generate an inference result. In this example, the processing D 113h to the processing F 113f are executed in this order, but the execution order may be free. In the embodiment, a program language of the machine learning program 113 is assumed to be Python, and may be a program language other than Python. The configuration example shown in FIG. 5 is an example of the machine learning program, and is not limited to this example. A plurality of processing parameters, processing, and the like necessary for machine learning can be described.

FIG. 6 is a configuration diagram showing a configuration example of the experiment record information according to the embodiment of the invention. In FIG. 6, the experiment record information 115 is information in which the machine learning program 113, the trained model 114, and the like used in a development stage by the data scientist are recorded (information indicating a history of the machine learning product including the machine learning program 113 and the trained model 114), and is managed as information in a table format. The experiment record information 115 includes the version 115a, the trained model ID (identification) 115b, the training program ID 115c, the inference program ID 115d, the sensor data ID 115e, and the accuracy 115f as a plurality of fields, and is stored in a database. At this time, in the experiment record information 115, the machine learning product including the machine learning program 113 and the trained model 114 trained by the training processing of the machine learning program 113 is recorded by being divided into a plurality of versions, and the accuracy (115f) of the inference obtained by the machine learning product of each version is recorded in association with each version of the machine learning product, the trained model, and the sensor data (training data). The database is implemented by an experiment record information storage unit that stores the experiment record information 115.

The version 115a is identification information (identifier) for uniquely identifying a version of the machine learning product including the machine learning program 113 and the trained model 114. For example, when the machine learning product is the first generated version, information of “1.0” is stored as an identifier in the version 115a. The trained model ID 115b is identification information (identifier) for uniquely identifying the trained model 114 belonging to the machine learning product. For example, when an identifier of the trained model belonging to the machine learning product whose version 115a is “1.0” is “AAA”, information of “AAA” is stored in the trained model ID 115b. In a process of developing the machine learning product, when the trained model is corrected and a new trained model is generated, a new ID is assigned to the newly generated trained model. The newly generated trained model is uniquely specified by the assigned ID.

The training program ID 115c is identification information (identifier) for uniquely identifying the training program 113a. For example, when an identifier of the training program belonging to the machine learning product whose version 115a is “1.0” is “DDD”, information of “DDD” is stored in the training program ID 115c. In a process of developing the machine learning product, when the training program 113a is corrected and a new training program is generated, a new ID is assigned to the newly generated training program. The newly generated training program is uniquely specified by the assigned ID.

The inference program ID 115d is identification information (identifier) for uniquely identifying the inference program 113b. For example, when an identifier of the inference program belonging to the machine learning product whose version 115a is “1.0” is “GGG”, information of “GGG” is stored in the inference program ID 115d. In a process of developing the machine learning product, when the inference program 113b is corrected and a new inference program is generated, a new ID is assigned to the newly generated inference program. The newly generated inference program is uniquely specified by the assigned ID.

The sensor data ID 115e is identification information (identifier) for uniquely identifying the sensor data 111. For example, when an identifier of the sensor data 111 used in the training processing of the machine learning product whose version 115a is “1.0” is “JJJ”, information of “JJJ” is stored in the sensor data ID 115e. In a process of developing the machine learning product, when the sensor data 111 is corrected and new sensor data is generated, a new ID is assigned to the newly generated sensor data. The newly generated sensor data is uniquely specified by the assigned ID.

The accuracy 115f is an accuracy of the inference of the machine learning product in each version, which is calculated based on the information recorded in the sensor data 111 and the information recorded in the annotation 112. Each field in FIG. 6 is an example of experiment management in the embodiment, and is not limited to this example. Any information can be stored in any field that can be generated as experiment management.

FIG. 7 is a configuration diagram showing a configuration example of the data acquisition condition according to the embodiment of the invention. In FIG. 7, the data acquisition condition 123 is data in a text format indicating an attribute of the sensor data 111, and includes a facility name 123a, a season 123b, a time zone 123c, and a unit 123d. The facility name 123a is a name of a facility (facility name) extracted from the sensor data 111. For example, “A1”, “A2”, and “A3” are stored, in the facility name 123a, as identifiers of the facility names extracted from the sensor data 111. The identifiers of the facility names extracted from the sensor data 111 are stored in the facility name 123a without duplication.

The season 123b is a season specified based on the date extracted from the sensor data 111. By collating the collection date stored in the sensor data 111 with the definition information 121 described later, information of a season, for example, “winter” and “spring” identified according to the conversion condition described in the definition information 121 is stored in the season 123b. The time zone 123c is a time zone specified based on the time extracted from the sensor data 111. By collating the collection time stored in the sensor data 111 with the definition information 121 described later, information of a time zone, for example, “night” and “morning” identified according to the conversion condition described in the definition information 121 is stored in the time zone 123c. The unit 123d is a unit specified based on the air temperature or the pressure extracted from the sensor data 111. By collating the air temperature or the pressure stored in the sensor data 111 with the definition information 121 described later, information of a unit, for example, “air temperature→° C.” and “pressure→kPa” identified according to the conversion condition described in the definition information 121 are stored in the unit 123d. The text format in FIG. 7 is an example of the data acquisition condition 123 in the embodiment, and is not limited to this example. Any information can be stored in any text format that can be generated as the data acquisition condition.

FIG. 8 is a configuration diagram showing a configuration example of the accuracy variation information according to the embodiment of the invention. In FIG. 8, the accuracy variation information 132 is information in which ranges (lower limit values, upper limit values) of the temperature and the pressure in the facility are recorded in a table format, and includes a facility name 132a, a minimum air temperature 132b, a maximum air temperature 132c, a minimum pressure 132d, and a maximum pressure 132e as a plurality of fields. The facility name 132a is similar to the facility name 111a of the sensor data 111. The minimum air temperature 132b is a minimum air temperature (lowest air temperature) when the inference result of the machine learning program 113 in each facility varies from normal to abnormal (deteriorated). For example, in a case where the minimum air temperature when the inference result of the machine learning program 113 in the facility name “A1” varies from normal to abnormal (deteriorated) is “10° C.”, information of “10” is stored in the minimum air temperature 132b. The maximum air temperature 132c is a maximum air temperature (highest air temperature) when the inference result of the machine learning program 113 in each facility varies from normal to abnormal (deteriorated). For example, in a case where the maximum air temperature when the inference result of the machine learning program 113 in the facility name “A1” varies from normal to abnormal (deteriorated) is “18° C.”, information of “18” is stored in the maximum air temperature 132c.

The minimum pressure 132d is a minimum pressure when the inference result of the machine learning program 113 in each facility varies from normal to abnormal (deteriorated). For example, in a case where the minimum pressure when the inference result of the machine learning program 113 in the facility name “A1” varies from normal to abnormal (deteriorated) is “1034.5 kPa”, information of “1034.5” is stored in the minimum pressure 132d. The maximum pressure 132e is a maximum pressure when the inference result of the machine learning program 113 in each facility varies from normal to abnormal (deteriorated). For example, in a case where the maximum pressure when the inference result of the machine learning program 113 in the facility name “A1” varies from normal to abnormal (deteriorated) is “2234.5 kPa”, information of “2234.5” is stored in the maximum pressure 132e.

FIG. 9 is a configuration diagram showing a configuration example of the accuracy contribution information according to the embodiment of the invention. In FIG. 9, the accuracy contribution information 142 is information for managing, for each data acquisition condition, an accuracy difference of the machine learning product, and is managed as information in a table format. At this time, the accuracy contribution information 142 includes a data acquisition condition 142a, a pre-contribution condition 142b, a post-contribution condition 142c, a training program 142d, an inference program 142e, and an accuracy difference 142f as a plurality of fields, and is stored in a database. The data acquisition condition 142a is an item for specifying, among the data acquisition conditions 123, a data acquisition condition in which there is a change between old and new versions of the machine learning product. Among the information (“facility name”, “season”, “time zone”, and “unit”) stored in the data acquisition condition 123, for example, the “season” is stored, in the data acquisition condition 142a, as an item of the data acquisition condition 123 in which there is an accuracy difference between versions of the machine learning product and there is a change between the old and new versions of the machine learning product.

The pre-contribution condition 142b is an item for specifying, among the data acquisition conditions 123, a data acquisition condition 123 in which an accuracy rate of the inference result in the old version of the machine learning product is high. In the pre-contribution condition 142b, for example, information of “winter” is stored as an item of the data acquisition condition 123 in which the accuracy rate of the inference result in the old version of the machine learning product is high.

The post-contribution condition 142c is an item for specifying, among the data acquisition conditions 123, a data acquisition condition 123 in which an accuracy rate of the inference result in the new version of the machine learning product is high. In the post-contribution condition 142c, for example, information of “winter, autumn” is stored as an item of the data acquisition condition 123 in which the accuracy rate of the inference result in the new version of the machine learning product is high.

The training program 142d is an item for specifying a processing parameter or processing in which there is a change difference in the training program 113a in the old and new versions of the machine learning product. In the training program 142d, for example, information of “processing A” is stored as processing in which there is a change difference in the training program 113a in the old and new versions of the machine learning product. When there is no corresponding processing parameter or processing, information of “-” is stored. In addition, the change difference of the training program 113a is a source code difference (difference of text) in a file format of the training program 113a, and is a change part of the training program 113a.

The inference program 142e is an item for specifying a processing parameter or processing in which there is a change difference in the inference program 113b in the old and new versions of the machine learning product. In the inference program 142e, for example, information of “processing E” is stored as processing in which there is a change difference in the inference program 113b in the old and new versions of the machine learning product. When there is no corresponding processing parameter or processing, information of “-” is stored. In addition, the change difference of the inference program 113b is a source code difference (difference of text) in a file format of the inference program 113b, and is a change part of the inference program 113b.

The accuracy difference 142f is an item for specifying a difference in the accuracy between the old and new versions of the machine learning product. For example, when the difference in the accuracy between the old and new versions of the machine learning product is “8”, information of “8” is stored in the accuracy difference 142f.

Here, when the information of the data acquisition condition 142a is a “season”, it means that the season in which the accuracy rate of the inference result obtained by the old version of the machine learning product is high is “winter”, and the season in which the accuracy rate of the inference result obtained by the new version of the machine learning product is high is “winter” and “autumn”. At this time, by using “autumn” as the season in which the accuracy rate of the inference result obtained by the new version of the machine learning product is high and by using the program in which “processing A” is changed as the training program 113a, the accuracy difference is improved by “8” compared with the case of using the season of “winter” as the old version of the machine learning product.

FIG. 10 is a configuration diagram showing a configuration example of the association information according to the embodiment of the invention. In FIG. 10, the association information 152 is information generated by the association processing unit 151, and is information in which a target associated with the data acquisition condition 123 is recorded for each machine learning product. The association information 152 is information managed in a table format, includes the machine learning product name 152a, a data acquisition condition 152b, accuracy variation information 152c, and the accuracy contribution information 152d as a plurality of fields, and is stored in a database. The machine learning product name 152a is identification information for uniquely identifying a name of the machine learning product. For example, when the machine learning product name is a “product A”, information of the “product A” is stored in the machine learning product name 152a.

The data acquisition condition 152b is an item for specifying information of the data acquisition condition 123 associated with a product name recorded in the machine learning product name 152a. In the data acquisition condition 152b, for example, information of “[facility names: A1, A2, A3] [season: winter, spring] [time zone: night, morning] [unit: air temperature→° C., pressure→kPa]” shown in FIG. 7 is stored as the data acquisition condition 123 associated with the product name “product A” recorded in the machine learning product name 152a.

The accuracy variation information 152c is an item for specifying the accuracy variation information 132 associated with the “facility name” among the information recorded in the data acquisition condition 152b. For example, when the facility name of the data acquisition condition 123 associated with the product name “product A” recorded in the machine learning product name 152a is “A1, A2, A3”, information of “[A1: minimum air temperature, 10, maximum air temperature, 18, minimum pressure, 1034.5, maximum pressure, 2234.5] [A2: minimum air temperature, 12, maximum air temperature, 20, minimum pressure, 1034.5, maximum pressure, 2234.5] [A3: minimum air temperature, 15, maximum air temperature, 23, minimum pressure, 1034.5, maximum pressure, 2234.5]” shown in FIG. 8 is stored, in the accuracy variation information 152c, as the accuracy variation information 132 associated with “A1, A2, A3” of the “facility name”.

The accuracy contribution information 152d is an item for specifying, for each data acquisition condition, the accuracy contribution information 142 associated with a “season”, a “time zone”, and a “facility name” among the information recorded in the data acquisition condition 152b. For example, information of “[season: winter, [winter, autumn], processing A, 8] [time zone: morning, [night, morning], processing E, 9] [facility name: A1, [A1, A2, A3], processing B, processing D, 10]” shown in FIG. 9 is stored, in the accuracy contribution information 152d, as the accuracy contribution information 142 for each data acquisition condition (“season”, “time zone”, and “facility name”).

FIG. 11 is a configuration diagram showing a configuration example of the definition information according to the embodiment of the invention. In FIG. 11, the definition information 121 is information in which a conversion condition for converting the sensor data 111 into an attribute thereof is defined, includes a facility name 121a, a season 121b, a time zone 121c, and a unit 121d as information in a text format, and is stored in a database. At this time, the conversion condition is defined as a conversion condition for converting, into a data acquisition condition, a character string or numerical data among the information recorded in the sensor data 111. When the data attribute extraction unit 120 refers to the definition information 121 based on the sensor data 111 and extracts the data acquisition condition 123 indicating the attribute from the sensor data 111, the data attribute extraction unit 120 converts the character string or the numerical data recorded in the sensor data 111 into the attribute according to the conversion condition, and extracts, from the sensor data 111, the converted attribute as the data acquisition condition 123.

For example, information of “A”, “B”, and “C” is recorded, in the facility name 121a, as a “Search word” which is a search character string for searching for a field having the information of the facility name from the field of the sensor data 111. In addition, for example, information of the facility names (“B” and “C”) before and after aggregation is recorded, in “Definition” of the facility name 121a, as a facility name when different facility names are aggregated into one name.

For example, information of “ [symbol] ”, “Date”, and “ [symbol] ” is recorded, in the season 121b, as a “Search word” which is a search character string for searching for a field having information of date from the field of the sensor data 111. In addition, for example, information of “spring: 03-01, 05-31”, “summer: 06-01, 08-31”, “autumn: 09-01, 11-30”, and “winter: 12-01, 02-29” is recorded, in “Definition” of the season 121b, as a conversion condition for converting the collection date recorded in the sensor data 111 into the season. At this time, when the collection date of the sensor data 111 is March 1 to May 31, the collection date is converted into “spring” of the season.

For example, information of “ [symbol] ” and “Time” is recorded, in the time zone 121c, as a “search word” which is a search character string for searching for a field having information of the collection time from the field of the sensor data. In addition, for example, information of “morning: 06:00, 11:59”, “noon: 12:00, 17:59”, and “night: 18:00, 05:59” is recorded, in “Definition” of the time zone 121c, as a conversion condition for converting the collection time recorded in the sensor data 111 into the time zone. At this time, when the collection time recorded in the sensor data 111 is 6:00 a.m. to 11:59 a.m., the collection time is converted into “morning” of the time zone.

Information of “Pressure” is recorded, in the unit 121d, as a “Search word” which is a search character string for searching for a field having numerical information of the time-series data and information of the unit of the numerical information from the field of the sensor data 111. In addition, for example, information of “Pressure” and “kPa” is recorded, in “Definition” of the unit 121d, as information of a unit associated with the information recorded in the “Search word”. In addition to “Pressure”, information of “air temperature” is also recorded, and in addition to “Pressure” and “kPa”, information of “°C” is also recorded, in “Definition”, as the “Search word”. In addition, the text format in FIG. 11 is an example of the definition information in the embodiment, and is not limited to this example. Any information can be stored in any text format that can be generated as the definition information.

### Flowchart Example

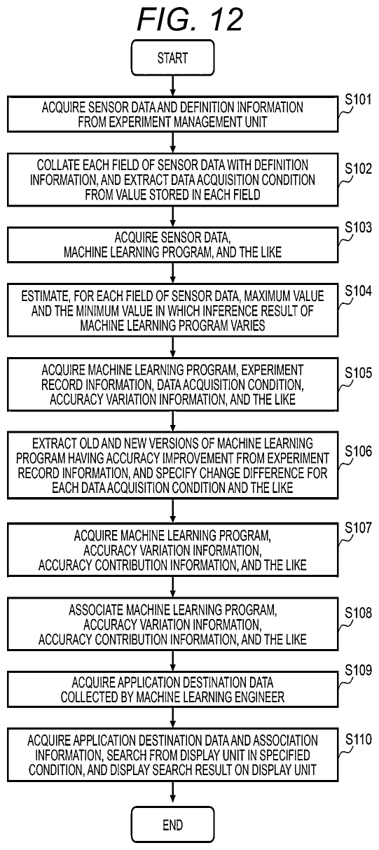

FIG. 12 is a flowchart showing an example of an operation of the development support server according to the embodiment of the invention.

In FIG. 12, first, in the data attribute extraction unit 120 of the development support server 100, the data acquisition condition extraction unit 122 acquires the sensor data 111 from the experiment management unit 110, and acquires the definition information 121 in the data attribute extraction unit 120 (S101).

Next, the data acquisition condition extraction unit 122 collates each field (“facility name”, “collection date”, “collection time”, “air temperature”, and “pressure”) of the acquired sensor data 111 with the information (“facility name”, “season”, “time zone”, and “unit”) described in the definition information 121, extracts the attribute of the sensor data 111 from the information (value) stored in each field, and stores the extracted each attribute of the sensor data 111 in the data acquisition condition 123 (S102).

Here, the collation between the information stored in each field of the sensor data 111 and the information described in the definition information 121 confirms whether the character string described in the “Search word” of the definition information 121 matches the column name of each field of the sensor data 111. The character string may not completely match the column name of each field, but may partially match and the like. For example, when the information (year, month, day) stored in the collection date 111b of the sensor data 111 is confirmed by collation with the “Search word”, the information of the collection date of all the rows stored in the field of the collection date 111b is acquired. The “Search word” corresponding to the collection date belongs to the season 121b of the definition information 121, the conversion condition described in the “Definition” of the season 121b is acquired, the collection date is converted into any one of the seasons (spring, summer, autumn, and winter) using the acquired conversion condition, it is confirmed to which season the collection date acquired from the field belongs, and the confirmed result is recorded in the season 123b of the data acquisition condition 123.

Next, the range and accuracy variation estimation unit 130 acquires the sensor data 111, the annotation 112, the machine learning program 113, and the trained model 114 from the experiment management unit 110 (S103).

At this time, the accuracy calculation unit 131 of the range and accuracy variation estimation unit 130 specifies, from the respective fields of the sensor data 111, a field in which numerical data is stored, adds or subtracts a constant to or from the specified numerical data, inputs numerical data, which is obtained by adding or subtracting the constant to or from the specified numerical data, and the trained model 114 to the machine learning program 113, infers the presence or absence of an abnormality of the facility by the machine learning program 113, and estimates a maximum value and a minimum value in which an inference result of the machine learning program 113 obtained by the inference varies (an upper limit value and a lower limit value of a range in which an inference accuracy of an inference result of the machine learning program 113 deteriorates) (S104).

At this time, when numerical data of the air temperature 111d is used as the numerical data in each field stored in the sensor data 111, the information stored in the abnormality 112d of the annotation 112 is “0”, that is, the facility is normal, and the maximum value and the minimum value are acquired from the numerical data stored in the air temperature 111d. Thereafter, a constant is added to or subtracted from the maximum value and the minimum value of the acquired numerical data (air temperature), the sensor data 111, which is obtained by adding or subtracting the constant to or from the maximum value and the minimum value of the numerical data, and the trained model 114 are input to the machine learning program 113, and the presence or absence of the abnormality of the facility is inferred by the machine learning program 113. At this time, the sensor data 111 to be received may be only data in a row in which the maximum value and the minimum value are stored, instead of the data in all the rows. When the result of the inference obtained by the machine learning program 113 is 0 (normal), the inference processing by adding or subtracting the constant again is repeated until the result of the inference becomes 1. When the result of the inference obtained by the machine learning program 113 is 1 (abnormal), a range (maximum value or minimum value) which is a value of the numerical data at this time is recorded in the accuracy variation information 132 as the maximum air temperature or the minimum air temperature.

For example, in a case where the result of the inference obtained by the machine learning program 113 using the minimum value of the numerical data (air temperature) is 1 (abnormal) and the value of the numerical data at this time is “10”, it means that a state of the facility varies from normal to abnormal (deteriorated) when the air temperature of the facility becomes “10° C.”, and thus “10” is recorded in the accuracy variation information 132 as the minimum air temperature when the state of the facility is abnormal (deteriorated). At this time, the accuracy calculation unit (range estimation unit) 131 sequentially executes inferences performed by the machine learning program 113 using a plurality of pieces of inference numerical data existing over a range wider than a range from the minimum value to the maximum value of the numerical data, estimates, as a lower limit value or an upper limit value of the range of the sensor data (training data) 111, the inference numerical data used when the result of the inference obtained by the machine learning program 113 becomes abnormal from normal, and generates the accuracy variation information 132 including the estimated lower limit value or upper limit value. The information recorded in the accuracy variation information 132 may be obtained by calculating, according to the known method disclosed in PTL 1, the range of the sensor data, in which the accuracy varies, based on the sensor data, the annotation, the machine learning program, and the trained model, and the accuracy variation information for each field of the sensor data is recorded.

Next, the acquisition condition and accuracy contribution processing specification unit 140 acquires the sensor data 111, the annotation 112, the machine learning program 113, the trained model 114, and the experiment record information 115 from the experiment management unit 110, acquires the data acquisition condition 123 from the data attribute extraction unit 120, and acquires the accuracy variation information 132 from the range and accuracy variation estimation unit 130 (S105).

At this time, the processing specification unit 141 of the acquisition condition and accuracy contribution processing specification unit 140 extracts old and new versions of the machine learning program (the machine learning program in which a numerical value of the accuracy 115f is improved) 113 contributing to the accuracy improvement of the trained model 114 from the experiment record information 115 generated in a trial and error process in the accuracy improvement of the machine learning product, and specifies a change difference for each data acquisition condition among the extracted old and new versions of the machine learning program 113 (specifies, for each data acquisition condition 123, the processing parameter and the processing which are change parts among the machine learning programs 113) (S106).

Here, for example, the season 123b described in the data acquisition condition 123 is described as an example. First, the processing specification unit 141 acquires the minimum values (minimum air temperature and minimum pressure) and the maximum values (maximum air temperature and maximum pressure) recorded in the accuracy variation information 132 for each facility name. For example, information (“10”) of the “minimum air temperature” is extracted from the facility name 132a in the fields of the accuracy variation information 132, as the minimum value recorded in the row of the facility name “A1”.

Next, the processing specification unit 141 extracts the information of only the row of the facility name “A1” from the facility name 111a in the fields of the sensor data 111, calculates the minimum value from the information (air temperature) recorded in the air temperature 111d among the extracted information, and compares the minimum value (minimum value of the sensor data) obtained by the calculation with the minimum value (minimum air temperature) recorded in the accuracy variation information 132. When the comparison results match, the processing specification unit 141 holds the minimum value obtained by the calculation as the minimum value of the air temperature in the sensor data 111. On the other hand, when the comparison result does not match, the processing specification unit 141 randomly extracts one row of the information of only the row of the facility name “A1”, replaces the information (air temperature) recorded in the air temperature 111d of the extracted row with the value of the minimum value (minimum air temperature) recorded in the accuracy variation information 132, and holds the replaced minimum value (minimum air temperature) as the minimum value of the air temperature in the sensor data 111 in a pseudo manner.

Thereafter, the processing specification unit 141 extracts, for example, information (“18”) of the “maximum air temperature” from the facility name 132a in the fields of the accuracy variation information 132, as the maximum value recorded in the row of the facility name “A1”.

Next, the processing specification unit 141 extracts information of only the row having the facility name “A1” from the facility name 111a in the fields of the sensor data 111, calculates the maximum value from the information (air temperature) recorded in the air temperature 111d among the extracted information, and compares the maximum value (maximum value of the sensor data 111) obtained by the calculation with the maximum value (maximum air temperature) recorded in the accuracy variation information 132. When the comparison results match, the processing specification unit 141 holds the maximum value obtained by the calculation as the maximum value of the air temperature in the sensor data 111. On the other hand, when the comparison result does not match, the processing specification unit 141 randomly extracts one row of the information of only the row of the facility name “A1”, replaces the information (air temperature) recorded in the air temperature 111d of the extracted row with the maximum value (maximum air temperature) recorded in the accuracy variation information 132, and holds the replaced maximum value (maximum air temperature) as the maximum value of the air temperature in the sensor data 111 in a pseudo manner. The processing specification unit 141 executes processing of comparing the sensor data 111 and the accuracy variation information 132 using a set of the minimum value and the maximum value.

Thereafter, the processing specification unit 141 sorts the data (numerical data) of the air temperature recorded in the air temperature 111d among the table data (data recorded in each field) recorded in the sensor data 111 in an ascending order, and divides the sorted data (numerical data) of the air temperature into a constant number of (a plurality of) groups in an ascending order.

Next, the processing specification unit 141 extracts the sensor data 111 matching the information recorded in the season 123b of the data acquisition condition 123, for example, the conditions of “winter” and “spring”, from the sensor data 111 of each of the divided groups, and compares, for each group, the accuracy of the inference obtained by the machine learning product using the extracted sensor data 111, for example, the sensor data 111 of “winter”, with the accuracy of the inference obtained by the machine learning product using the sensor data 111 of “winter” and “spring”, based on the information recorded in the experiment record information 115.

When it is determined that the inference accuracy is improved for the sensor data 111 belonging to all the groups, the processing specification unit 141 specifies, among the information recorded in the experiment record information 115, the old and new versions of the machine learning product in which the accuracy of the inference is improved. At this time, the processing specification unit 141 divides a plurality of the data acquisition conditions 123 extracted by the data attribute extraction unit 120 into a plurality of groups for each data acquisition condition, refers to the experiment record information 115 based on the data acquisition conditions 123 belonging to each group, specifies, for each group, a machine learning product in which the accuracy of the inference is improved between the old and new versions among the plurality of machine learning products recorded in the experiment record information 115, and specifies, for each group, a change difference of the machine learning program 113 belonging to the specified machine learning product.

The processing specification unit 141 performs the above processing on the minimum pressure 132d and the maximum pressure 132e in the fields of the accuracy variation information 132, and when it is determined that the inference accuracy is improved in each processing, the processing specification unit 141 specifies, for the minimum pressure and the maximum pressure, the old and new versions of the machine learning product in which the inference accuracy is improved among the information recorded in the experiment record information 115.

When the old and new versions of the machine learning product specified for the minimum air temperature, the maximum air temperature, the minimum pressure, and the maximum pressure match each other, the processing specification unit 141 specifies a difference of the machine learning program 113 for the minimum air temperature, the maximum air temperature, the minimum pressure, and the maximum pressure. At this time, the processing specification unit 141 extracts a source code difference (text difference) in a file format of the machine learning program 113, and specifies the extracted source code difference as a difference (change difference) indicating a change part of the machine learning program 113.

The processing specification unit 141 generates, for example, a “season” among the target data acquisition conditions (“season”, “time zone”, “facility name”, and “unit”) as information of the data acquisition condition 142a, generates, as information of the pre-contribution condition 142b, for example, “winter” which is the information belonging to the data acquisition condition 142a and has a high accuracy rate of the inference result obtained by the old version of the machine learning product, and generates, as information of the post-contribution condition 142c, for example, “winter” and “autumn” which are the information belonging to the data acquisition condition 142a and have a high accuracy rate of the inference result obtained by the new version of the machine learning product. In addition, the processing specification unit 141 refers to the machine learning program 113 and the experiment record information 115, generates, as information of the training program 142d, for example, “processing A” which is the processing indicating the difference of the machine learning program 113 and the change difference (change part) of the training program 113a between the old and new versions of the machine learning product, generates, as information of the inference program 142e, the processing indicating the difference of the machine learning program 113 and the change difference of the inference program 113b between the old and new versions of the machine learning product, generates, as information of the accuracy difference 142f, for example, “8” which is a difference of the accuracy (the information recorded in the accuracy 115f of the experiment record information 115) between the old and new versions of the machine learning product, and generates the accuracy contribution information 142 from each type of generated information.

That is, the processing specification unit 141 specifies the change difference of the machine learning program 113 belonging to the machine learning product in which the accuracy of inference is improved, specifies, for each data acquisition condition, the processing parameters 113c and 113g or the processing 113d to 113f and 113h to 113j belonging to at least one program of the training program 113a and the inference program 113b belonging to the machine learning program 113 as the change difference of the machine learning program 113, and records the specified processing parameters or processing in the accuracy contribution information 142.

Next, the acquisition condition and range and accuracy contribution processing association management unit 150 acquires the machine learning program 113 and the trained model 114 from the experiment management unit 110, acquires the data acquisition condition 123 from the data attribute extraction unit 120, acquires the accuracy variation information 132 from the range and accuracy variation estimation unit 130, and acquires the accuracy contribution information 142 from the acquisition condition and accuracy contribution processing specification unit 140 (S107).

Thereafter, the association processing unit 151 belonging to the acquisition condition and range and accuracy contribution processing association management unit 150 executes processing of associating the machine learning program 113, the trained model 114, the data acquisition condition 123, the accuracy variation information 132, and the accuracy contribution information 142 with one another in order to input the application destination data 162 and search the machine learning program 113 and the trained model 114 by the search unit 170 (S108). At this time, for example, in a case where the “product A” which is the machine learning product including the machine learning program 113 and the trained model 114 performs an inference using the information recorded in the data acquisition condition 123 in FIG. 7 as the information recorded in the data acquisition condition 123, the association processing unit 151 associates the data acquisition condition 152b with the “product A” by using the information (“[facility name: A1, A2, A3] [season: winter, spring] [time zone: night, morning] [unit: air temperature→° C., pressure→kPa]”) recorded in the data acquisition condition 123 in FIG. 7 as the information of the data acquisition condition 152b.

In addition, the association processing unit 151 associates the data acquisition condition 152b and the accuracy variation information 152c using, among the information recorded in the data acquisition condition 152b, the information ([A1: minimum air temperature, 10, maximum air temperature, 18, minimum pressure, 1034.5, maximum pressure, 2234.5] [A2: minimum air temperature, 12, maximum air temperature, 20, minimum pressure, 1034.5, maximum pressure, 2234.5] [A3: minimum air temperature, 15, maximum air temperature, 23, minimum pressure, 1034.5, maximum pressure, 2234.5]) recorded in the accuracy variation information 132 corresponding to the “[facility name: A1, A2, A3]”, for example, the accuracy variation information 132 in FIG. 8 as the information of the accuracy variation information 152c.

Further, the association processing unit 151 associates the accuracy contribution information 152d and the data acquisition condition 152b using, in the information recorded in the data acquisition condition 152b, the information (“[season: winter, [winter, autumn], processing A, 8] [time zone: morning, [night, morning], processing E, 9] [facility name: A1, [A1, A2, A3], processing B, processing D, 10]”) recorded in the accuracy contribution information 142 for each data acquisition condition ([facility name] [season] [time zone]), for example, the accuracy contribution information 142 shown in FIG. 9 as the accuracy contribution information 152d.

Next, the data acquisition unit 160 acquires data collected by an application destination system in which the machine learning engineer performs the technique verification (S109). Specifically, the data input unit 161 belonging to the data acquisition unit 160 inputs data, for example, time-series data including a facility name, a collection date, a collection time, an air temperature, and a pressure, which is collected by the application destination system in which the machine learning engineer performs the technique verification, and stores the input time-series data as the application destination data 162 in a database. Data generated by the data scientist, for example, the sensor data 111, the annotation 112, the machine learning program 113, the trained model 114, and the experiment record information 115 may also be stored using the data input unit 161.

When the application destination data 162 specifying a file is input from the search screen of the display unit 200, the search unit 170 calls the data acquisition condition extraction unit 122 and the accuracy calculation unit 131, and requests the data acquisition condition extraction unit 122 and the accuracy calculation unit 131 to perform processing on the application destination data 162. At this time, the data acquisition condition extraction unit 122 extracts data acquisition conditions (application destination data acquisition conditions) corresponding to attributes (“facility name”, “season”, “time zone”, and “unit”) of the sensor data 111 from the data recorded in the application destination data 162, and outputs the extracted application destination data acquisition conditions, for example, “facility name—A1”, “season—winter”, “time zone—night, morning”, and “unit—air temperature→° C.” to the search unit 170. In addition, the accuracy calculation unit 131 calculates a minimum value and a maximum value of numerical data stored in each field of the application destination data 162, and outputs the calculation result as the minimum value and the maximum value of the range of the application destination data 162. For example, when the numerical data stored in the field of the application destination data 162 is a “temperature”, a minimum value of the temperature, for example, “8” is calculated as the minimum air temperature, and a maximum value of the temperature, for example, “12” is calculated as the maximum air temperature.

At this time, the search unit 170 outputs, to the display unit 200, information (“facility name—A1”, “season—winter”, “time zone—night, morning”, and “unit—air temperature→° C.”) related to the data acquisition condition (application destination data acquisition condition) of the application destination data 162 and information related to the minimum value (minimum air temperature) and the maximum value (maximum air temperature) of the range of the application destination data 162 as information related to input data for search. The data acquisition condition extraction unit 122 may add, to the search unit 170, a function of extracting a data acquisition condition (application destination data acquisition condition) corresponding to the attribute of the sensor data 111 from the data recorded in the application destination data 162. In addition, the accuracy calculation unit 131 may add, to the search unit 170, a function of calculating the minimum value and the maximum value of the numerical data stored in each field of the application destination data 162.

The search unit 170 searches the information (table data) recorded in the association information 152 using the information (“facility name—A1”, “season—winter”, “time zone—night, morning”, and “unit—air temperature→° C.”) related to the data acquisition condition (application destination data acquisition condition) of the application destination data 162 as a search key, extracts, for example, a machine learning program A, a machine learning program B, and a machine learning program C as the machine learning program 113 belonging to the machine learning product using the application destination data 162, extracts, from the information (table data) recorded in the association information 152, information (the accuracy variation information 152c and the accuracy contribution information 152d) in a row of table data matching the search key, and transmits, to the display unit 200, the extracted information as information of a search result (information associated with the application destination data acquisition condition of the application destination data 162). When the information of the search result transmitted from the search unit 170 is received, the display unit 200 displays the received information of the search result on the screen and presents the displayed information to the machine learning engineer (S110).

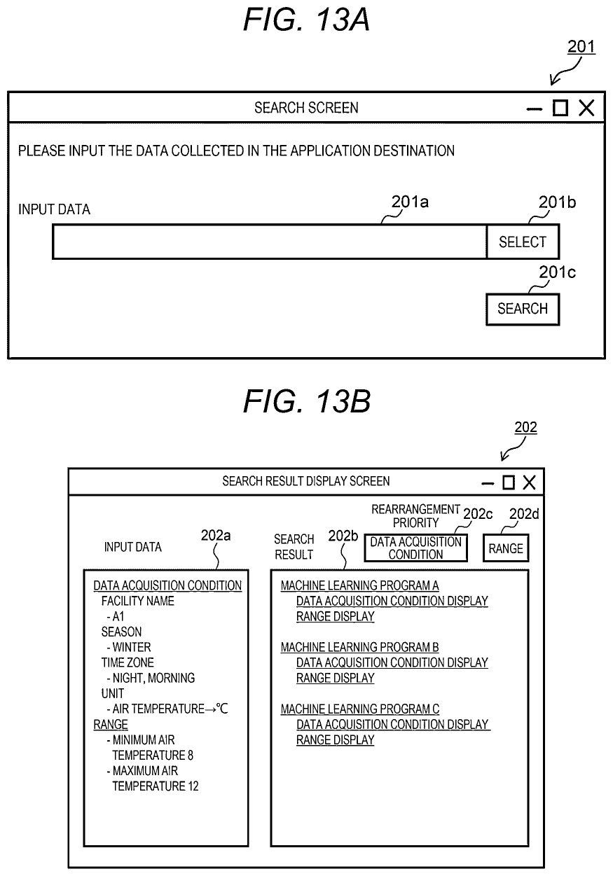

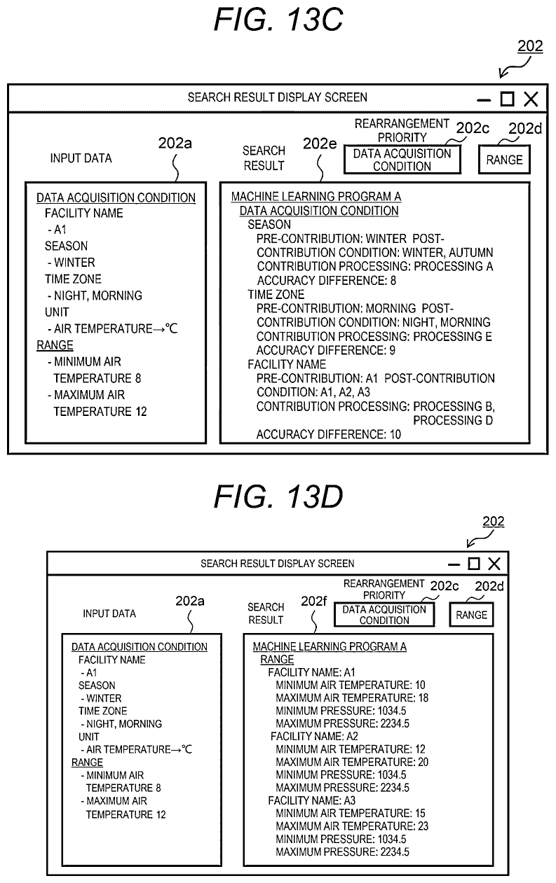

FIG. 13A is a configuration diagram showing a display example of a search screen of the display unit according to the embodiment of the invention. In FIG. 13A, the search screen 201 of the display unit 200 includes an input data box 201a for displaying input data, a select button 201b for selecting the input data displayed in the input data box 201a, and a search button 201c for executing a search according to the input data.

FIG. 13B is a configuration diagram showing a first display example of a search result display screen of the display unit according to the embodiment of the invention. In FIG. 13B, a search result display screen 202 of the display unit 200 is a screen after input data is specified by an operation of the select button 201b and then the search button 201c is operated on the search screen 201 of the display unit 200 shown in FIG. 13A, and includes an input data display region 202a for displaying the input data, a search result display region 202b for displaying a search result, a data acquisition condition button 202c for displaying a data acquisition condition, and a range button 202d for displaying a range.

In the input data display region 202a, as the search result of the search unit 170, data acquisition conditions (facility name—A1, season—winter, time zone—night, morning, unit—air temperature→° C.) of the input data and a range (minimum air temperature: 8, maximum air temperature: 12) are displayed. In the search result display region 202b, the machine learning program A, the machine learning program B, and the machine learning program C are displayed as the machine learning programs belonging to the machine learning product matching the search key. In a region below each of the machine learning programs A to C, character strings of “data acquisition condition display” and “range display” are displayed.

Accordingly, it is possible to present the data acquisition conditions (facility name—A1, season—winter, time zone—night, morning, unit—air temperature→° C.) and the range (minimum air temperature: 8, maximum air temperature: 12) of the input data to the machine learning engineer, and it is possible to present the machine learning program A, the machine learning program B, and the machine learning program C to the machine learning engineer as the machine learning programs belonging to the machine learning product matching the search key.

Here, for example, when the “data acquisition condition display” of the machine learning program A is clicked, the screen of FIG. 13B transitions to a screen of FIG. 13C, and when the “range display” is clicked, the screen of FIG. 13B transitions to a screen of FIG. 13D.

FIG. 13C is a configuration diagram showing a second display example of a search result display screen of the display unit according to the embodiment of the invention. In FIG. 13C, the search result display screen 202 of the display unit 200 is a screen transitioned from the screen of FIG. 13B, and includes the input data display region 202a for displaying the input data, a search result display region 202e for displaying the search result, the data acquisition condition button 202c for displaying the data acquisition condition, and the range button 202d for displaying the range.

In the input data display region 202a, the same information as that of the search result display screen 202 of FIG. 13B is displayed. In the search result display region 202e, detailed information of the data acquisition condition of the machine learning program A is displayed. For example, information (pre-contribution: winter, post-contribution condition: winter, autumn, contribution processing: processing A, accuracy difference: 8) in a row of the “season” of the accuracy contribution information 142 is displayed as the “season” of the data acquisition condition, information (pre-contribution: morning, post-contribution condition: night, morning, contribution processing: processing E, accuracy difference: 9) in a row of the “time zone” of the accuracy contribution information 142 is displayed as the “time zone” of the data acquisition condition, and information (pre-contribution: A1, post-contribution conditions: A1, A2, A3, contribution processing: processing B, processing D, accuracy difference: 10) in a row of the “facility name” of the accuracy contribution information 142 is displayed as the “facility name” of the data acquisition condition.

Accordingly, the detailed information of the data acquisition condition of the machine learning program A can be presented to the machine learning engineer.

FIG. 13D is a configuration diagram showing a display example of a search result display screen of the display unit according to the embodiment of the invention. In FIG. 13D, the search result display screen 202 of the display unit 200 is a screen transitioned from the screen of FIG. 13B, and includes the input data display region 202a for displaying the input data, a search result display region 202f for displaying the search result, the data acquisition condition button 202c for displaying the data acquisition condition, and the range button 202d for displaying the range.

In the input data display region 202a, the same information as that of the search result display screen 202 of FIG. 13B is displayed. In the search result display region 202f, detailed information of the range of the machine learning program A is displayed. For example, information (minimum air temperature: 10, maximum air temperature: 18, minimum pressure: 1034.5, maximum pressure: 2234.5) in a row of the facility name “A1” of the accuracy variation information 132, information (minimum air temperature: 12, maximum air temperature: 20, minimum pressure: 1034.5, maximum pressure: 2234.5) in a row of the facility name “A2” of the accuracy variation information 132, and information (minimum air temperature: 15, maximum air temperature: 23, minimum pressure: 1034.5, maximum pressure: 2234.5) in a row of the facility name “A3” of the accuracy variation information 132 are displayed as the ranges when the machine learning program A is used in the facility name “A1”.

Accordingly, the detailed information of the range of the machine learning program A can be presented to the machine learning engineer.

In the embodiment, when the information related to the data acquisition condition 123 is included in metadata of data or attached data, the data attribute extraction unit 120 may extract, by the data acquisition condition extraction unit 122, the data acquisition condition by analyzing the metadata or the attached data.

In addition, in the embodiment, the range and accuracy variation estimation unit 130 estimates accuracy variation by focusing on the range of the numerical data in the table data recorded in the sensor data 111, and may target values other than the range of the numerical data. For example, by variously changing brightness and the like of image data, it is possible to estimate whether the variation of the accuracy occurs.

Further, in the embodiment, the acquisition condition and accuracy contribution processing specification unit 140 targets the experiment record information 115 of the abnormality detection of the facility related to the sensor data 111 attached to the facility of the factory, and the acquisition condition and accuracy contribution processing specification unit 140 can be applied to various machine learning methods as long as the inference accuracy can be calculated.

According to the embodiment, it is possible to specify a machine learning product with an improved inference accuracy according to an attribute of sensor data (training data), based on experiment record information indicating a history of a machine learning product including a machine learning program and a trained model. Further, according to the embodiment, by displaying accuracy contribution information in which a relationship between a change difference of the machine learning program belonging to the specified machine learning product and the machine learning program is collected for each data acquisition condition, it is possible to present, to a machine learning engineer, a processing content and a processing parameter of the machine learning program contributing to accuracy improvement. Further, according to the embodiment, a data acquisition condition and a range of application destination data can be presented to the machine learning engineer, and a machine learning program belonging to a machine learning product matching a search key can be presented to the machine learning engineer. In addition, it is possible to present, to the machine learning engineer, detailed information of the data acquisition condition and detailed information of the range of the machine learning program belonging to the machine learning product matching the search key.

The invention is not limited to the embodiments described above and includes various modifications. The embodiments described above are described in detail to facilitate understanding of the invention, and the invention is not necessarily limited to those including all the described configurations. A part of the configuration of one embodiment can be replaced with the configuration of another embodiment, and the configuration of another embodiment can be added to the configuration of one embodiment. In addition, with respect to a part of a configuration of each embodiment, addition, deletion, or replacement of another configuration can be applied singly or in combination.

Some or all of the configurations, functions, processing units, processing methods, and the like described above may be implemented by hardware by, for example, designing with an integrated circuit. In addition, the above configurations, functions, and the like may be implemented by software by a processor interpreting and executing a program for implementing each function. Information such as a program, a table, and a file for implementing each function can be stored in a recording device such as a memory, a hard disk, and a solid state drive (SSD), or in a recording medium such as an IC card, an SD card, and a DVD.

In addition, control lines and information lines considered to be necessary for description are shown in the drawings, and not all control lines and information lines in a product are necessarily shown. In practice, all the components may be considered to be connected to one another as necessary.

What is claimed is:

1. A machine learning development support system comprising:
a data storage unit configured to store training data used in training processing of a machine learning program;
a data attribute extraction unit configured to refer to, based on the training data received from the data storage unit, definition information in which a conversion condition for converting the training data into an attribute thereof is defined, and extract a plurality of data acquisition conditions indicating the attribute from the training data;
an experiment record information storage unit configured to store experiment record information, in which a machine learning product including the machine learning program and a trained model trained by the training processing of the machine learning program is divided into a plurality of versions and recorded, and an accuracy of an inference obtained by each of the versions of the machine learning product is recorded in association with the version of the machine learning product, the trained model, and the training data; and
a processing specification unit configured to refer to the experiment record information for each of the data acquisition conditions extracted by the data attribute extraction unit, and specify, for each of the data acquisition conditions, a machine learning product in which the accuracy of the inference is improved between old and new versions among the versions of the machine learning product recorded in the experiment record information.

2. The machine learning development support system according to claim 1, wherein
the processing specification unit generates accuracy contribution information by collecting, for each of the data acquisition conditions, a relationship between a change difference of the machine learning program belonging to the specified machine learning product and the machine learning program.

3. The machine learning development support system according to claim 2, wherein
the training data is implemented by table data including a plurality of columns and rows, and a character string or numerical data is recorded in each row of each column of the table data,
the conversion condition is defined as a conversion condition for converting the character string or the numerical data into each of the plurality of data acquisition conditions, and
the data attribute extraction unit converts the character string or the numerical data into the attribute according to the conversion condition, and extracts the converted attribute as the data acquisition condition from the training data.

4. The machine learning development support system according to claim 3, further comprising:
a range estimation unit configured to estimate a range of the training data in which an inference result obtained by the training processing of the machine learning program using the trained model and the training data varies from normal to abnormal, wherein
the range estimation unit sequentially executes inferences performed by the machine learning program using a plurality of pieces of inference numerical data existing over a range wider than a range from a minimum value to a maximum value of the numerical data, estimates, as a lower limit value or an upper limit value of the range of the training data, the inference numerical data used when a result of an inference obtained by the machine learning program becomes abnormal from normal, and generates accuracy variation information including the estimated lower limit value or upper limit value.

5. The machine learning development support system according to claim 4, further comprising:
an association processing unit configured to associate each of the plurality of machine learning products recorded in the experiment record information with each of the plurality of data acquisition conditions extracted by the data attribute extraction unit, wherein
the association processing unit associates, with the accuracy variation information generated by the range estimation unit, the data acquisition condition associated with the machine learning product, and associates, with the accuracy contribution information generated by the processing specification unit, the data acquisition condition associated with the machine learning product to generate association information.

6. The machine learning development support system according to claim 5, further comprising:
a search unit configured to search the association information using information recorded in received input data as a search key; and
a display unit configured to display the information obtained by the search of the search unit, wherein
the search unit extracts an application destination data acquisition condition corresponding to the attribute of the training data from the application destination data when application destination data acquired from a target of technique verification is input as the input data, extracts, as information associated with the extracted application destination data acquisition condition, at least one of the accuracy variation information and the accuracy contribution information from the association information, and outputs the extracted information to the display unit.

7. The machine learning development support system according to claim 2, wherein
the processing specification unit specifies the change difference of the machine learning program belonging to the machine learning product in which the accuracy of the inference is improved, specifies, as the change difference of the machine learning program, a processing parameter or processing belonging to at least one of a training program and an inference program belonging to the machine learning program for each of the data acquisition conditions, and records the specified processing parameter or processing in the accuracy contribution information.

8. The machine learning development support system according to claim 1, wherein
the processing specification unit divides the plurality of data acquisition conditions extracted by the data attribute extraction unit into a plurality of groups for each of the data acquisition conditions, refers to the experiment record information based on the data acquisition conditions belonging to each of the groups, specifies, for each of the groups, a machine learning product in which the accuracy of the inference is improved between the old and new versions among the plurality of machine learning products recorded in the experiment record information, and specifies, for each of the groups, a change difference of the machine learning program belonging to the specified machine learning product.

9. A machine learning development support method using a computer, the machine learning development support method comprising:
a data storage step of storing training data used in training processing of a machine learning program;
a data attribute extraction step of referring to, based on the training data stored in the data storage step, definition information in which a conversion condition for converting the training data into an attribute thereof is defined, and extracting a plurality of data acquisition conditions indicating the attribute from the training data;
an experiment record information storage step of storing experiment record information, in which a machine learning product including the machine learning program and a trained model trained by the training processing of the machine learning program is divided into a plurality of versions and recorded, and an accuracy of an inference obtained by each of the versions of the machine learning product is recorded in association with the version of the machine learning product, the trained model, and the training data; and
a processing specification step of referring to the experiment record information for each of the data acquisition conditions extracted by the data attribute extraction step, and specifying, for each of the data acquisition conditions, a machine learning product in which the accuracy of the inference is improved between old and new versions among the versions of the machine learning product recorded in the experiment record information.

10. The machine learning development support method according to claim 9, wherein
the processing specification step is to generate accuracy contribution information by collecting, for each of the data acquisition conditions, a relationship between a change difference of the machine learning program belonging to the specified machine learning product and the machine learning program.

11. The machine learning development support method according to claim 10, wherein
the training data is implemented by table data including a plurality of columns and rows, and a character string or numerical data is recorded in each row of each column of the table data,
the conversion condition is defined as a conversion condition for converting the character string or the numerical data into each of the plurality of data acquisition conditions, and
the data attribute extraction step is to convert the character string or the numerical data into the attribute according to the conversion condition, and extract the converted attribute as the data acquisition condition from the training data.

12. The machine learning development support method according to claim 11, further comprising:
a range estimation step of estimating a range of the training data in which an inference result obtained by the training processing of the machine learning program using the trained model and the training data varies from normal to abnormal, wherein
the range estimation step is to sequentially execute inferences performed by the machine learning program using a plurality of pieces of inference numerical data existing over a range wider than a range from a minimum value to a maximum value of the numerical data, estimate, as a lower limit value or an upper limit value of the range of the training data, the inference numerical data used when a result of an inference obtained by the machine learning program becomes abnormal from normal, and generate accuracy variation information including the estimated lower limit value or upper limit value.

13. The machine learning development support method according to claim 12, further comprising:
an association processing step of associating each of the plurality of machine learning products recorded in the experiment record information with each of the plurality of data acquisition conditions extracted by the data attribute extraction step, wherein
the association processing step is to associate, with the accuracy variation information generated by the range estimation step, the data acquisition condition associated with the machine learning product, and associate, with the accuracy contribution information generated by the processing specification step, the data acquisition condition associated with the machine learning product to generate association information.

14. The machine learning development support method according to claim 13, further comprising:
a search step of searching the association information using information recorded in received input data as a search key; and
a display step of displaying the information obtained by the search in the search step, wherein
the search step is to extract an application destination data acquisition condition corresponding to the attribute of the training data from the application destination data when application destination data acquired from a target of technique verification is input as the input data, extract, as information associated with the extracted application destination data acquisition condition, at least one of the accuracy variation information and the accuracy contribution information from the association information, and output the extracted information as the information obtained by the search.

15. The machine learning development support method according to claim 10, wherein
the processing specification step is to specify the change difference of the machine learning program belonging to the machine learning product in which the accuracy of the inference is improved, specify, as the change difference of the machine learning program, a processing parameter or processing belonging to at least one of a training program and an inference program belonging to the machine learning program for each of the data acquisition conditions, and record the specified processing parameter or processing in the accuracy contribution information.
